(19) United States
(12) Patent Application Publication
(10) Pub. No.: US 2011/0239479 A1
(43) Pub. Date: Oct. 6, 2011

(54) Tape measure

(76) Inventors: Ronald R. Chisholm, Truro (CA); Peter G. Alex, Antigonish (CA)

(21) Appl. No.: 12/662,097

(22) Filed: Mar. 31, 2010

(51) Int. Cl. G01B 3/10

(52) U.S. Cl. 33/770

(57) ABSTRACT

A tape measure includes a casing containing a conventional tape with a hook on its outer end and a return spring. A magnifying lens is mounted in a front end of the casing above the tape with an indicator line on the bottom of the lens extending transversely of the tape. An LED in one side of the casing illuminates the lens and the area therebeneath. A marker is slidable in the lens beside the tape and aligned with the indicator line. A slider, which can be operated with a thumb, turns on the LED and then pushes the marker against a workpiece. When the slider is released, a spring returns the marker to the rest or non-use position and the LED is turned off by the slider.

### BACKGROUND OF THE INVENTION

This invention relates to a tape measure.

1. Field of the Invention

In particular, the invention relates to a tape measure containing a magnifying lens, a light and a marker for making a mark on a workpiece when taking a measurement.

2. Description of Related Art

There are many patents and applications relating to tape measures including some form of marker, magnifying lens and/or light. Examples of such patents and applications are CA 1,287,972, issued to M. Legare on Aug. 27, 1991, CA 2,234,942, issued to M. D. Potter et al on Nov. 21, 2006, U.S. Pat. No. 2,992,487, issued to O. A. Miller on Jul. 18, 1961, U.S. Pat. No. 3,205,584, issued to C. H. Overaa on Sep. 14, 1965, U.S. Pat. No. 4,015,337, issued to J. A. Taylor on Apr. 5, 1977, U.S. Pat. No. 4,296,554, issued to E. A. Hammerstrom on Oct. 27, 1981, U.S. Pat. No. 4,462,160, issued to H. Cohen et al on Jul. 31, 1984, U.S. Pat. No. 4,580,347, issued to F. H. McKnight on Apr. 8, 1986, U.S. Pat. No. 4,630,376, issued to R. L. Pentecost on Dec. 23, 1986, U.S. Pat. No. 4,760,648, issued to S. W. Doak et al on Aug. 2, 1988, U.S. Pat. No. 5,671,543, issued to T. A. Sears on Sep. 30, 1997, U.S. Pat. No. 6,030,091, issued to C. L. Li on Feb. 29, 2000, U.S. Pat. No. 6,178,655, issued to M. D. Potter et al on Jan. 30, 2001, U.S. Pat. No. 6,209,219, issued to D. I. Wakefield et al on Apr. 3, 2001, U.S. Pat. No. 6,434,854, issued to I. C. MacColl et al on Aug. 20, 2002, U.S. Pat. No. 6,574,881, issued to R. E. Cole III on Jun. 10, 2003, U.S. Pat. No. 6,892,469, issued to B. D. Tufts et al on May 17, 2005, U.S. Pat. No. 7,174,655, issued to L. A. Gibbons et al on Feb. 13, 2007 and US 2007/0101600 (T. L. Alders), published May 10, 2007.

The devices disclosed by the patent literature include a magnifying lens, a light and/or a marker. However, many of the devices incorporating a light are designed merely to illuminate an area in the general vicinity of a tape, i.e. they do not concentrate light in the area where a measurement is being made. For the most part, the measuring tapes with markers are somewhat rudimentary and include a pencil, which, unless sharp, would not make a fine line or mark on a workpiece at the desired location. Many of the devices require two hands to operate and/or are structurally complicated and consequently would be expensive to manufacture

### BRIEF SUMMARY OF THE INVENTION

The present invention provides a relatively simple, streamline tape measure incorporating a magnifying lens, a light and a marker, all of which are in close proximity to each other and to the tape, enabling accurate marking of a workpiece.

Accordingly, the present invention relates to a tape measure comprising:

a casing;

a tape in said casing with indicia thereon, said tape being adapted to be extended from said casing for making a measurement and retractable into said casing to a storage, non-use position;

a magnifying lens mounted in a front end of said casing above an outer free end of said tape when the tape is in the non-use position;

a light in said casing for illuminating said lens and the tape therebeneath;

an indicator line associated with said lens immediately above and extending transversely of said tape in vertical alignment with said indicia during measurements;

a marker slidable in said lens between a retracted position in said casing and an extended position exterior to said casing for making a mark on a workpiece at one end of said indicator line during measurement;

a switch in said casing for actuating said light; and

a slider movable on said casing for sequentially operating said switch and said marker when the tape has been extended to a desired length indicated by said indicator line.

### BRIEF DESCRIPTION OF THE DRAWINGS

FIGS. 1 and 2 are isometric views of a tape measure in accordance with the invention;

FIG. 3 is a top view of the tape measure of FIGS. 1 and 2;

FIG. 4 is a front view of the tape measure of FIGS. 1 to 3;

FIG. 5 is a bottom view of the tape measure of FIGS. 1 to 4;

FIG. 6 is a schematic side view of an electrical circuit used in the tape measure of FIGS. 1 to 5, and

FIGS. 7 and 8 are schematic, longitudinal section views of the tape measure of FIGS. 1 to 5 in the non-use and use conditions, respectively.

### DETAILED DESCRIPTION OF THE INVENTION

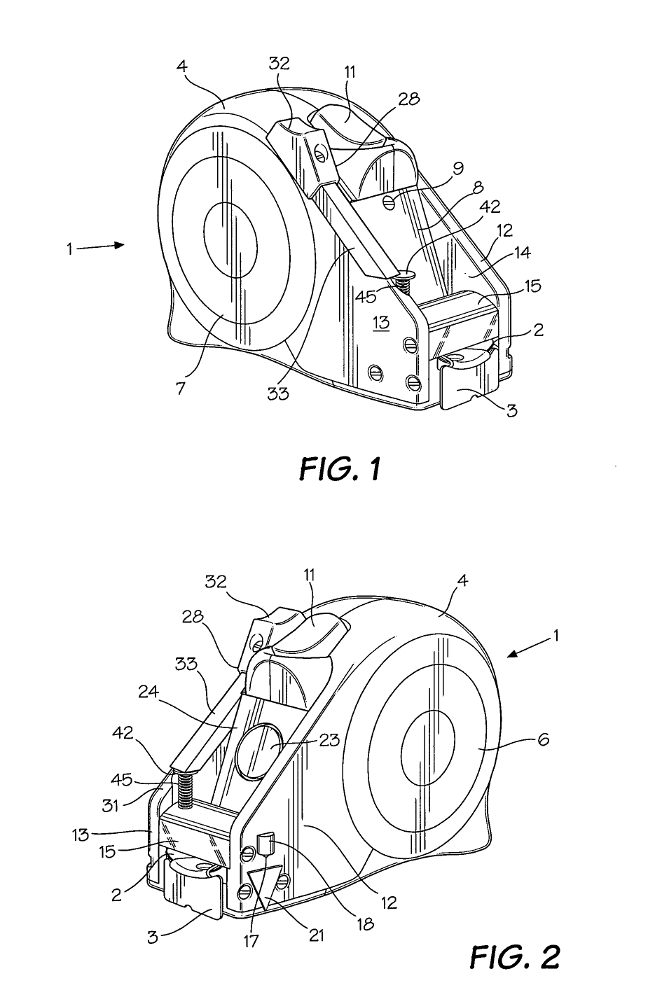

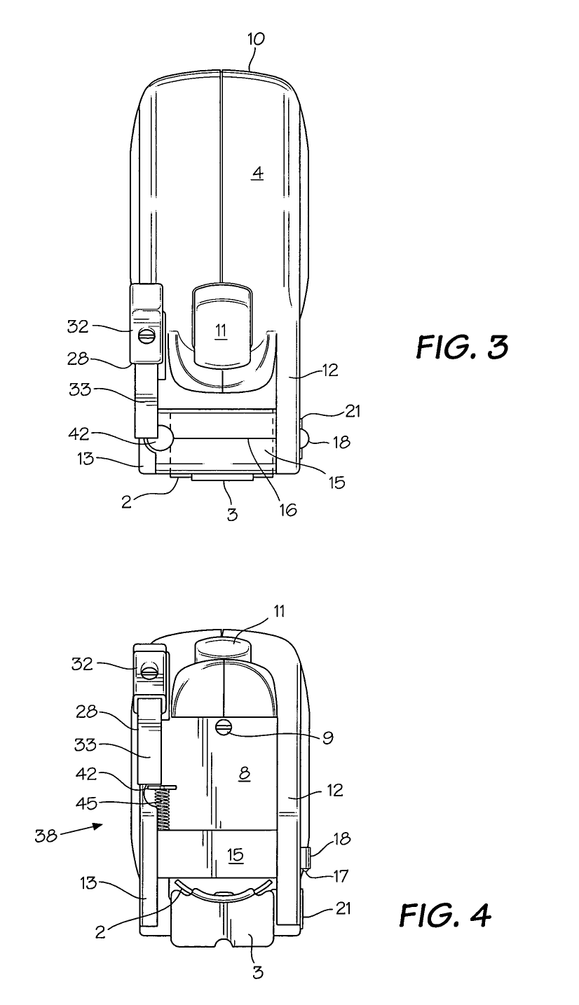

With reference to FIGS. 1 to 5, a tape measure in accordance with the invention includes a casing indicated generally at 1 containing a conventional coiled tape 2 (FIG. 3), a return spring (not shown), and a hook 3 on the outer free end of the tape 2. The casing 1 is defined by a convex top wall 4, a bottom wall 5, side walls 6 and 7, a front wall defined by a removable cover 8 attached to the remainder of the casing by a screw 9, and a rear wall 10. A thumb operated, slidable button 11 on the front of the top wall 4 is used to operate a conventional brake (not shown) for releasably locking the tape (not shown) in an extended position. Straight extensions 12 and 13 project forwardly from the sides of the casing 1. The extensions 12 and 13 define a well 14 (FIG. 1) with the bottom wall 5 and the front of the casing 1. A clear plastic, magnifying lens 15 is mounted in the well 14 between the front ends of the extensions 12 and 13 above the front end of the tape 2 and the rear end of the hook 3 when the tape is in the retracted position shown in the drawings. The lens 15 has a convex top surface. Thus, the tape 2 is magnified when viewed from above. A black line 16 (FIG. 3) is provided on the bottom of the lens 15. The line 16 extends between the ends of the lens 16 perpendicular to the longitudinal axis of the tape i.e. transversely of the casing 1. While the line 16 could be incorporated in the lens 15, it is preferable that the line is located on the bottom of the lens to avoid parallax errors. Light from an LED 17 shines through the lens and lights up the area beneath the lens 15 including the line 16 and the tape 2, making it easier to read the indicia on the tape and providing a line across the tape indicating the length of tape extending from the casing 1. The LED 17 is mounted in a semi-cylindrical projection 18 on the extension 11. A small hole (not shown) in the extension 11 admits light to the lens 15.

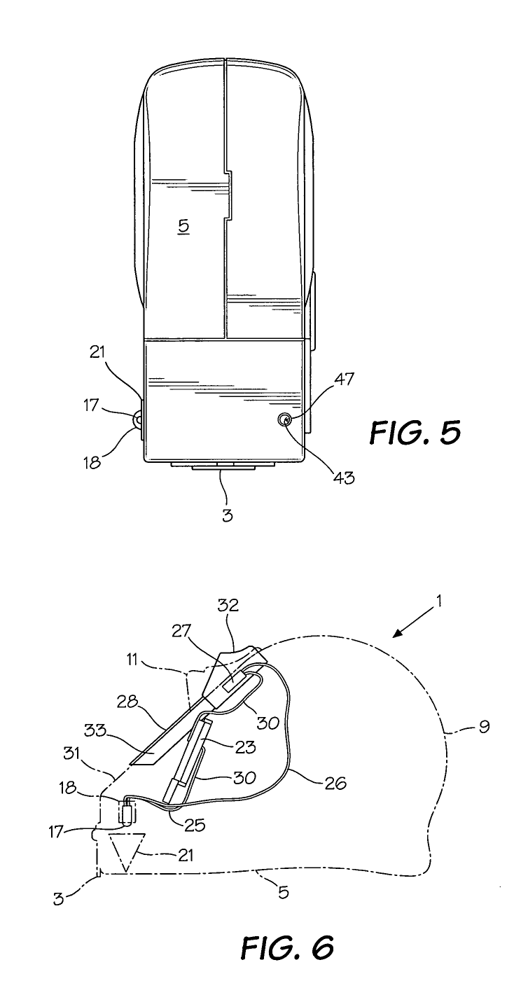

The LED 17 extends slightly out of the bottom end of the housing 18 (FIGS. 4 and 5) so that the LED provides light to an area beneath a triangular alignment pointer 21. The pointer 21 is aligned with the line 16 through the lens 15.

Power for the LED 17 is supplied by a battery 23 (FIGS. 2 and 6) mounted in a compartment 24 (FIG. 2) behind the cover 8. Wires 25 and 26 connect the LED 17 to the battery 23 and to a switch 27, respectively. The switch 27 is mounted in the top front of the casing 1 for activation by a slider 28. Another wire 30 connects the switch 27 to the battery 23.

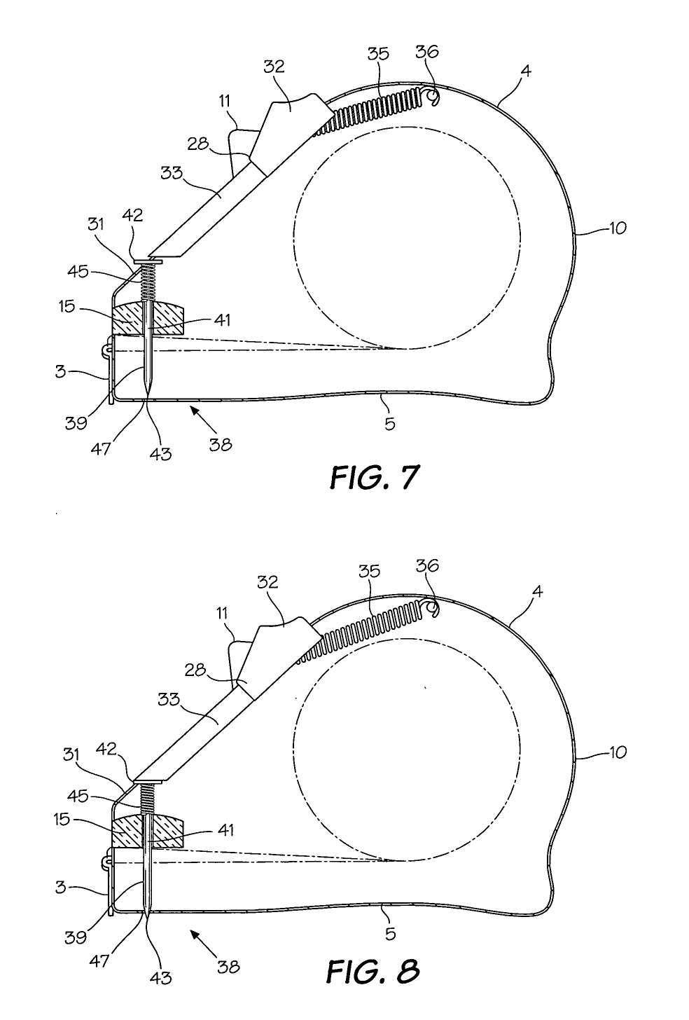

As best shown in FIGS. 1, 2, 7 and 8, the slider 28, which is slidable on a ramp 31 defined by the inclined top edge of the extension 13, includes a plastic push bottom 32 at its top end and an elongated, stainless steel bottom end 33. The slider 28 is biased upwardly to a rest position (FIG. 6) on the ramp 31 by a helical spring 35, one end of which is connected to the end 32 of the slider and the other end of which is connected to the casing 1 by a pin 36 (FIGS. 6 and 7). The slider 28 can be operated by a user's thumb, i.e. the tape measure can be operated using one hand.

Downward movement of the slider 28 activates a marker assembly indicated generally at 38 in FIGS. 7 and 8. The marker assembly includes a steel, nail-shaped marker 39 slidable in the lens 15. The marker 39 has an elongated body 41 with a disc-shaped head 42 on the top end thereof and a pointed bottom end 43. The marker 39 is located close to the tape 2, and the pointed bottom end 43 is aligned with the line 16. A helical spring 45 coaxial with the body 41 is sandwiched between the head 42 and the top of the lens 15.

In operation, the button 32 is pushed using a thumb or finger. When the slider 28 moves downwardly on the ramp 31 (FIGS. 2, 7 and 8) defined by the inclined top edge of the arm 13, the slider button closes the switch 27 to turn on the LED 17. When the line 16 on the bottom of the lens 15 is vertically aligned with the proper indicia on the tape 2, i.e. if the desired measurement has been made, the slider 28 is pushed further down along the ramp 31. At the same time, the button 11 is contacted with the user's thumb or a finger to actuate the tape brake. Because the tape brake-operating button 11 is located in side-by-side and slightly below the button 32 at the top end of the slider 28, a thumb can be used to push both buttons at the same time or sequentially. The bottom end of the slider 28 bears against the head 42 of the marker 39, pushing the marker downwardly through an opening 47 in the bottom wall 5 of the casing 1 (FIG. 8) to leave a mark in or on a surface abutting the bottom wall 5. The spring 45 is compressed between the head 42 of the marker 39 and the top of the lens 15. When the slider 28 is released, the spring 35 returns the slider to the rest position (FIG. 7) turning off the LED 17, and the spring 45 returns the marker 39 to the rest position.

1. A tape measure comprising:
a casing;
a tape in said casing with indicia thereon, said tape being adapted to be extended from said casing for making a measurement and retractable into said casing to a storage, non-use position;
a magnifying lens mounted in a front end of said casing above an outer free end of said tape when the tape is in the non-use position;
a light in said casing for illuminating said lens and the tape therebeneath;
an indicator line associated with said lens immediately above and extending transversely of said tape in vertical alignment with said indicia during measurements;
a marker slidable in said lens between a retracted position in said casing and extended position exterior to said casing for making a mark on a workpiece at one end of said indicator line during measurement;
a switch in said casing for actuating said light; and
a slider movable on said casing for sequentially operating said switch and said marker when the tape has been extended to a desired length indicated by said indicator line.

2. The tape measure of claim 1, wherein said casing includes a top wall, a bottom wall, first and second side walls, a front wall, a rear wall and first and second spaced apart, parallel extensions projecting forwardly from said side walls and defining a well with said front wall and a front end of said bottom wall, said well containing a free end of the tape when in a retracted position in the casing, said lens and said marker.

3. The tape measure of claim 2, including a ramp on said first extension slidably supporting said slider.

4. The tape measure of claim 3, including an alignment pointer on an exterior surface of said second extension aligned with said marker.

5. The tape measure of claim 4, including a projection on said second extension above said pointer carrying said light; and a hole in said second extension for admitting light to the lens in the well.

6. The tape measure of claim 3, including a brake for locking the tape in one position; a first button slidable on said casing for operating the brake; and a second button at a top end of said slider for moving the slider downwardly on said ramp.

7. The tape measure of claim 6, including a first spring extending between said casing and said slider for returning the slider to the non-use position.

8. The tape measure of claim 7, wherein said marker includes an elongated body slidable in said lens, and a head on said body for engagement by a bottom end of said slider for moving the body to the extended position.

9. The tape measure of claim 8, wherein said marker includes a second spring between said head and said lens for returning the marker to a non-use position in said casing.

10. The tape measure of claim 7, wherein said second button is in close side-by-side relationship with and slightly above said first button, whereby both buttons can be pushed sequentially with a thumb or finger.
